(19) United States
(12) Patent Application Publication
(10) Pub. No.: US 2013/0068199 A1
(43) Pub. Date: Mar. 21, 2013

(54) HIGH PRESSURE SOLENOID

(71) Applicants: Mark S. Cerny, Metamora, MI (US); Christopher R. Glaspie, Rochester Hills, MI (US)

(72) Inventors: Mark S. Cerny, Metamora, MI (US); Christopher R. Glaspie, Rochester Hills, MI (US)

(73) Assignee: CHRYSLER GROUP LLC., Auburn Hills, MI (US)

(21) Appl. No.: 13/238,244

(22) Filed: Sep. 21, 2011

(51) Int. Cl. F02M 51/06; B23P 11/00; H01F 7/126; F02M 61/14

(52) U.S. Cl. 123/470; 239/585.1; 29/888.01; 335/278

(57) ABSTRACT

A solenoid that includes a housing having an outer surface and an inner surface, the inner surface defining a bore through the housing and the outer surface including a flange extending therefrom. A gland nut having a threaded outer surface and an inner surface surrounds the outer surface of the housing, is rotatable relative to the housing, and abuts the flange.

### FIELD

The present disclosure relates to a high pressure solenoid, and more particularly to a high pressure solenoid having a threaded gland nut that allows simple assembly and re-alignment of electrical connectors as well as decrease required service time when the solenoid requires maintenance.

### BACKGROUND

It is important in the design of high pressure solenoids, especially fuel injectors, to provide a device which is both easy to assemble and service.

A typical fuel injector is assembled by fitting the housing of the fuel injector into an opening in a combustion chamber of an engine. In low pressure applications, the fuel injector is held in place via only a friction fit with the opening in the intake manifold. In higher pressure applications, the fuel injector is typically held in place through both a friction fit with the opening in the combustion chamber and a separate clamping assembly attached to a surface in the cylinder head.

It is typically very difficult to remove a fuel injector during a servicing operation because a large amount of force/leverage is required to overcome the friction fit holding the fuel injector in place. In modern engines, there is sometimes not enough room in the engine compartment of a vehicle for a service technician to apply the require amount of force/leverage for removal.

Also, during an assembly/re-assembly operation, it is typically very difficult and time consuming to properly align the electrical connectors of the fuel injectors before fitting the fuel injector in pace in its opening. If alignment is riot correct, the electrical connection can not be properly made and the fuel injector must be removed and re-aligned.

### SUMMARY

In one form, the present disclosure provides a solenoid that includes a housing having an outer surface and an inner surface, the inner surface defining a bore through the housing and the outer surface including a flange extending therefrom, and a gland nut having a threaded outer surface and an inner surface, the inner surface of the gland nut being dimensioned to surround the outer surface of the housing and abut the flange.

In another form, the present disclosure provides a solenoid fluid injector assembly having a tubular housing with an outer surface and an inner surface, the inner surface defining a bore through the housing and the outer surface including a flange extending radially therefrom. An actuator subassembly and a valve member subassembly are positioned within the bore and electromagnetically coupled to each other, and a terminal is coupled to the actuator assembly. A gland nut having a threaded outer surface and an inner surface surrounds the outer surface of the housing, is rotatable relative to the housing, and abuts the flange.

In yet another form, the present disclosure provides a method of assembling an engine that includes a) providing a solenoid fluid injector having a tubular housing with a bore therethrough and an outer surface including a flange extending radially therefrom, an actuator subassembly positioned within the bore, a valve member subassembly positioned within the bore and electromagnetically coupled to the actuator subassembly, a terminal coupled to the actuator assembly, and a gland nut having a threaded outer surface and an inner surface, the inner surface of the gland nut being dimensioned to surround the outer surface of the housing, be rotatable relative to the housing, and abut the flange; b) providing an automotive component having a threaded opening; c) locating the solenoid fluid injector within the threaded opening of the automotive component; d) rotating the housing relative to the gland nut so as to position the terminal in a desired orientation; and e) rotating the gland nut so as to engage the threads of the gland nut with the threaded opening while maintaining the desired orientation of the terminal.

Further areas of applicability of the present disclosure will become apparent from the detailed description, drawings and claims provided hereinafter. It should be understood that the detailed description, including disclosed embodiments and drawings, are merely exemplary in nature, intended for purposes of illustration only, and are not intended to limit the scope of the invention, its application, or use. Thus, variations that do not depart from the gist of the invention are intended to be within the scope of the invention.

### BRIEF DESCRIPTION OF THE DRAWINGS

FIG. 1 is a cross sectional view of a high pressure solenoid configured as a fuel injector according to an aspect of the present invention; and

FIG. 2 is a cross sectional view of the high pressure solenoid of FIG. 1 positioned within a threaded opening in an automotive component.

### DETAILED DESCRIPTION

The following detailed description illustrates the present invention incorporated into a fuel injector solenoid. It will be readily apparent to one of skill in the art that the present invention is applicable outside of a fuel injector solenoid configuration and can be configured for use in any automotive component for the purpose of hydraulic flow or pressure control. For example, one of skill in the art will recognize that the solenoid can be configured for use within an electrohydromechanical valvetrain for the purpose of controlling both hydraulic flow and pressure to engine valves so as to control valve lift and timing, or for use in anti-lock braking systems.

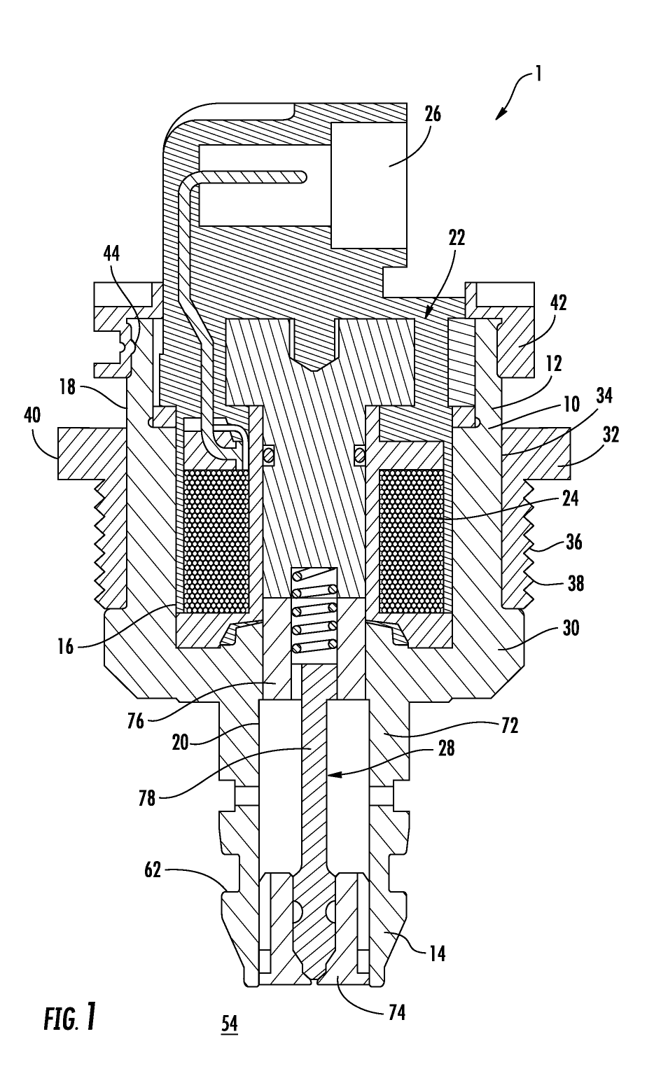

Referring now to FIG. 1, a high pressure solenoid configured as a fuel injector 1 according to the teachings of the invention is shown. The fuel injector 1 includes a tubular housing 10 having an upper portion 12, a lower portion 14, an inner surface 16 and an outer surface 18. A bore 20 extends through the housing 10.

An electromagnetic actuator subassembly 22 is positioned within the bore 20 at the upper portion 12 of the housing 10. The electromagnetic actuator subassembly 22 includes a coil 24 and a terminal 26 that actuates the coil 24. The terminal 26 extends out from the actuator subassembly 22 for connection to a lead (not shown) for selectively energizing the coil 24. A combined valve guide 72, seat 74, armature 76 and valve member 78 subassembly 28 is located within the bore 20 at the lower portion 14 of the housing 10. Energizing of the coil 24 causes reciprocal movement of the armature 76 within subassembly 28. This reciprocal movement is used to direct a spray of fuel into a combustion chamber associated with the fuel injector 1.

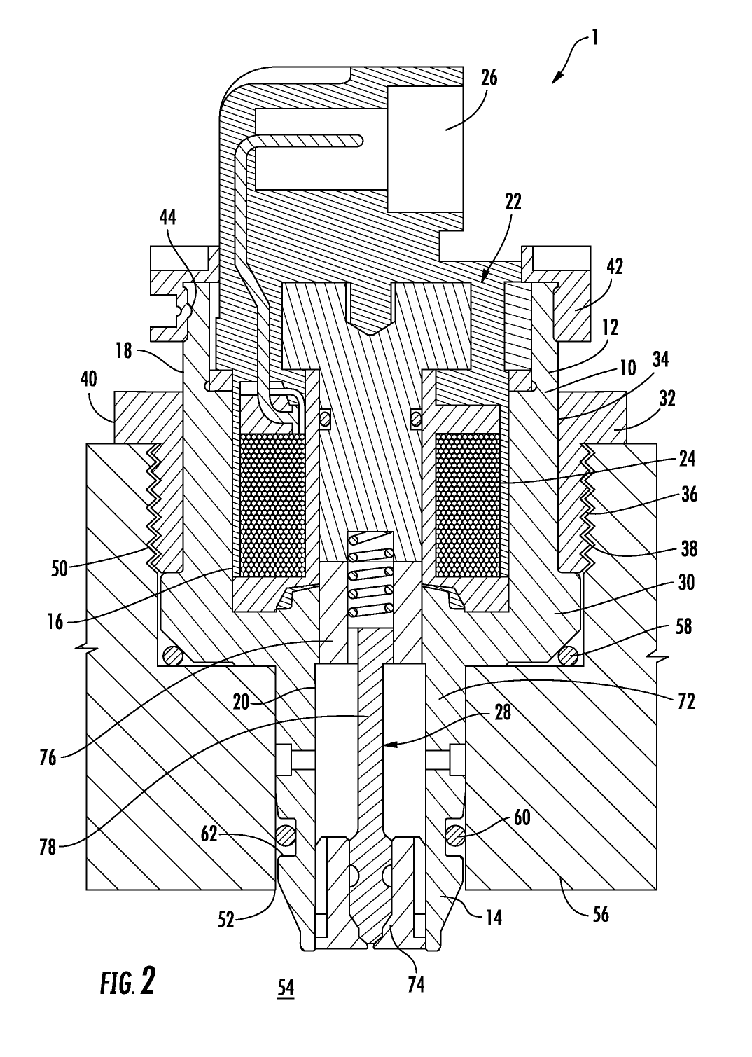

The outer surface 18 of the housing 10 includes a radially outwardly extending flange portion 30 encircling the housing 10 at approximately the midportion thereof. A gland nut 32 is provided around the outer surface 18 of the housing 10, adjacent to and abutting the flange portion 30. An inner surface 34 of the gland nut 32 is configured so as to allow the gland nut 32 to rotate relative to the housing 10. An outer surface 36 of the gland nut 32 includes a thread 38 along a lower portion thereof, and an upper portion of the gland nut 32 is provided with angled linear surfaces 40 configured to be gripped by a tool such that the gland nut 32 can be rotated and engaged with corresponding threads within an opening in an automotive component, such as the corresponding threads 50 within an opening 52 in the cylinder head 56 of the engine as shown in more detail in FIG. 2.

The fuel injector 1 also preferably has a ring retainer 42 attached to the upper portion 12 of the housing 10. In the configuration shown in FIG. 1, the ring retainer 42 is crimped onto a groove 44 provided on the upper portion 12 of the housing 10 so that the gland nut 32 is retained between the ring retainer 42 and the flange portion 30. In other configurations, the ring retainer can be held in place with other retention features, including but not limited to providing the ring retainer with a thread and screwing the ring retainer onto a corresponding thread on the upper portion of the housing, providing a set screw to hold the ring retainer in place, or using swaging to hold the ring retainer in place.

The ring retainer 42 keeps the gland nut 32 from being separated from the housing 10 while also allowing the gland nut 32 to rotate relative to the housing 10. In addition, and as shown in FIG. 1, the ring retainer 42 can be configured to overlap the upper portion 12 of the housing 10 so as to assist in holding the actuator subassembly 22 within the bore 20. As described in more detail below, the use of the ring retainer 42 also provides benefits in the overall serviceability of the solenoid.

Referring now to FIG. 2, the fuel injector 1 is shown attached to tie cylinder head 56 with the lower housing 14 protruding through an opening 52 into the combustion chamber 54. As shown in FIG. 2, the cylinder head 56 incorporates a thread 50 corresponding to the thread 38 on the gland nut 32 of tie fuel injector 1. During assembly/re-assembly, the fuel injector 1 is placed in tie opening 52 and the terminal 26 is aligned in a desired orientation. This orientation of the terminal 26 is possible because the housing 10 is rotatable relative to the gland nut 32. After the terminal 26 is in the desired orientation, the gland nut 32 is rotated so that the thread 38 of the gland nut 32 engages the thread 50 of the opening 52. During this engagement of the threads of the gland nut 32 and the opening 52, the terminal 26 can be held in its desired orientation while the gland nut 32 is continuously rotated until a first O-ring seal 58 is seated against a shoulder within the opening 52. As shown in FIG. 2, depending on the configuration of the fuel injector 1, a second O-ring seal 60 can be provided in a channel 62 in the lower portion 14 of the housing 10 so as to seat against a wall of the opening 52 of the cylinder head 56 and thereby provide an additional seal.

One of the important improvements realized with the use of the ring retainer is the increased serviceability of the solenoid. Because the gland nut 32 is positioned between the ring retainer 42 and the flange 30, and rotatable relative to the housing 10, when a service operation is carried out to remove the solenoid, the gland nut 32 is unscrewed and pushes against the ring retainer 42 to assist in forcing the solenoid out of the opening in the automotive component. This extra leverage provided by the gland nut 32 against the retainer ring 42 allows the solenoid to be easily extracted.

With the above described configuration, assembly/repair of the fuel injector is simplified and assembly/repair time can be significantly decreased.

What is claimed is:

1. A solenoid comprising:
a housing having an outer surface and an inner surface, the inner surface defining a bore through the housing and the outer surface including a flange extending therefrom; and
a gland nut having a threaded outer surface and an inner surface, the inner surface of the gland nut being dimensioned to surround the outer surface of the housing and abut the flange.

2. The solenoid of claim 1, wherein the gland nut is rotatable relative to the housing.

3. The solenoid of claim 1, wherein the housing is tubular.

4. The solenoid of claim 3, wherein the flange extends radially from the outer surface of the housing.

5. The solenoid of claim 1, further comprising a ring retainer secured to and extending from the housing at a location wherein the gland nut is positioned between the ring retainer and the flange.

6. The solenoid of claim 5, wherein the ring retainer is secured to the housing with a crimp.

7. The solenoid of claim 6, wherein the housing includes a groove to engage the crimp.

8. The solenoid fluid injector of claim 5, wherein the ring retainer is dimensioned so as to prevent the gland nut from being removed from the housing while the ring retainer is secured to the housing.

9. A solenoid fluid injector assembly comprising:
a tubular housing having an outer surface and an inner surface, the inner surface defining a bore through the housing and the outer surface including a flange extending radially therefrom;
an actuator subassembly positioned within the bore;
a valve member subassembly positioned within the bore and electromagnetically coupled to the actuator subassembly;
a terminal coupled to the actuator assembly; and
a gland nut having a threaded outer surface and an inner surface, the liner surface of the gland nut being dimensioned to surround the outer surface of the housing, be rotatable relative to the housing, and abut the flange.

10. The solenoid fluid injector of claim 9, further comprising a ring retainer secured to and extending from the housing at a location wherein the gland nut is positioned between the ring retainer and the flange.

11. The solenoid fluid injector of claim 10, wherein the ring retainer is secured to the housing with a crimp.

12. The solenoid fluid injector of claim 11, wherein the housing includes a groove to engage the crimp.

13. The solenoid fluid injector of claim 10, wherein the ring retainer is dimensioned so as to prevent the gland nut from being removed from the housing while the ring retainer is secured to the housing.

14. The solenoid fluid injector of claim 9, wherein the solenoid fluid injector is configured as a fuel injector.

15. An automotive fluid control system comprising:
an automotive component having a threaded opening; and
the solenoid fluid injector according to claim 9 positioned within the threaded opening, wherein the threaded outer surface of the gland nut corresponds to the threaded opening in the automotive component.

16. The engine of claim 15, wherein the automotive component is a cylinder head.

17. A method of assembling an engine, the method comprising:
a) providing a solenoid fluid injector that includes:
a tubular housing having an outer surface and an inner surface, the inner surface defining a bore through the housing and the outer surface including a flange extending radially therefrom;
an actuator subassembly positioned within the bore;
a valve member subassembly positioned within the bore and electromagnetically coupled to the actuator subassembly;
a terminal coupled to the actuator assembly; and
a gland nut having a threaded outer surface and an inner surface, the inner surface of the gland nut being dimensioned to surround the outer surface of the housing, be rotatable relative to the housing, and abut the flange;
b) providing an automotive component having a threaded opening;
c) locating the solenoid fluid injector within the threaded opening of the automotive component;
d) rotating the housing relative to the gland nut so as to position the terminal in a desired orientation; and
e) rotating the gland nut so as to engage the threads of the gland nut with the threaded opening while maintaining the desired orientation of the terminal.

18. The method of claim 17, further comprising securing a ring retainer to the housing at a location wherein the gland nut is positioned between the ring retainer and the flange.

19. The method of claim 18, wherein the ring retainer is secured to the housing with a crimp.
